(19) United States
(12) Patent Application Publication
(10) Pub. No.: US 2018/0339948 A1
(43) Pub. Date: Nov. 29, 2018

(54) Microgranular Water-soluble Fertilizer Co-produced from Potassium Nitrate by Tower Melt and Method of Preparing the Same

(71) Applicant: STANLEY AGRICULTURAL GROUP CO., LTD., Linyi City, Shandong (CN)

(72) Inventors: Jinhua GAO, Linyi City, Shandong (CN); Weiguang FENG, Linyi City, Shandong (CN); Xiangzhao GAO, Linyi City, Shandong (CN); Huitao BIAN, Linyi City, Shandong (CN); Qinzheng XU, Linyi City, Shandong (CN); Wenping LI, Linyi City, Shandong (CN); Qingcai SHI, Linyi City, Shandong (CN); Tingting WANG, Linyi City, Shandong (CN); Ran CUI, Linyi City, Shandong (CN); Shouxue HE, Linyi City, Shandong (CN); Ning LI, Linyi City, Shandong (CN); Duan WANG, Linyi City, Shandong (CN); Hongxia LIU, Linyi City, Shandong (CN); Jun ZHANG, Linyi City, Shandong (CN); Fei ZHANG, Linyi City, Shandong (CN); Wenqi LEI, Linyi City, Shandong (CN); Xiangfu CHEN, Linyi City, Shandong (CN); Wenlong YU, Linyi City, Shandong (CN)

(21) Appl. No.: 15/779,249

(22) PCT Filed: Mar. 15, 2017
(86) PCT No.: PCT/CN2017/076834

§ 371 Date: May 25, 2018

(30) Foreign Application Priority Data
Mar. 16, 2016 (CN) 201610148296.0

(51) Int. Cl. C05B 11/04; C05C 5/02; C05C 5/00; C05C 9/00; C05D 9/02; C05G 3/00

(52) U.S. Cl. CPC C05B 11/04; C05C 5/02; C05C 5/005; C05G 3/0094; C05D 9/02; C05G 3/0058; C05C 9/005

(57) ABSTRACT

Disclosed are a microgranular water-soluble fertilizer co-produced from potassium nitrate by tower melt and a method of preparing the same, which relate to the technical field of production of water-soluble fertilizers. The microgranular water-soluble fertilizer co-produced from potassium nitrate by tower melt is prepared from potassium nitrate concentrate, urea, industrial monoammonium phosphate, water-soluble ammonium polyphosphate, potassium sulfate, EDTA-Fe, EDTA-Zn, EDTA-Mn, boric acid and ammonium heptamolybdate. The microgranular water-soluble fertilizer product co-produced from potassium nitrate by tower melt has balanced and stable nutrients. The product is microgranular, has a smooth appearance, is less susceptible to agglomeration, is easy to be absorbed and utilized by crops, and contains a full range of nutrients. In addition, the product is produced by a process employing fully automatic dispensing equipment, which mainly integrates “dispensing, mixing and packaging” and is fully automated. The process is environmentally friendly, energy saving, and easy for manufacturing.

The present disclosure claims priority from Chinese Patent Application No. CN201610148296.0 filed with the Chinese Patent Office on Mar. 16, 2016, entitled “Microgranular Water-soluble Fertilizer Co-produced from Potassium Nitrate by Tower Melt and Method of Preparing the Same”, the entire contents of which are incorporated herein by reference.

### TECHNICAL FIELD

The present invention pertains to the technical field of production of water-soluble fertilizers, and in particular relates to a microgranular water-soluble fertilizer co-produced from potassium nitrate by tower melt and a method of preparing the same.

### BACKGROUND ART

Water-soluble fertilizer is a complex compound fertilizer which has a remarkable effect as a fast-acting fertilizer. The formula of the fertilizer can be adjusted in accordance with the crops. The more important characteristic of the water-soluble fertilizer is that it can be produced with little manpower. Its production can effectively reduce manpower cost, save water, save fertilizers and save labor.

The water-soluble fertilizer has a broad market prospect in China. Increasing number of water-soluble fertilizers with full water solubility and full absorption are accepted by dealers and farmers. This greatly motivates domestic enterprises to actively engage in research, development and promotion of the water-soluble fertilizer industry. Related enterprises are currently investing in the construction of water-soluble fertilizer production devices.

The process of preparing the water-soluble fertilizer includes two kinds of processes, namely, physical blending and chemical synthesis.

The physical blending means that raw material fertilizers containing nutrients such as nitrogen, phosphorus, and potassium are blended directly into a water-soluble fertilizer in a physical mixing manner in accordance with an adequate formula by mechanical equipment such as a pretreatment apparatus and a mixer. Due to the low level of technical creativity, the production method by simple physical blending makes an enterprise lack core competitiveness and capacity for sustainable development. Moreover, the method has a low barrier so that any enterprises can produce a water-soluble fertilizer using the method, leading to a disordered competition in the industry. Further, a water-soluble fertilizer product prepared by physical blending has a poor appearance as various chemical fertilizer raw materials have discrepancies in shapes, grain sizes, colors, etc., resulting in a product which is not good in either grain size or color and which is prone to caking and agglomeration, causing difficulties in sales and use.

The chemical synthesis means that a variety of raw materials containing nutrients such as nitrogen, phosphorus, and potassium are subjected to a series of specified chemical reactions and processes such as dissolution, filtration for removing impurity, reaction, concentration by evaporation and crystallization by cooling at a specified temperature, pH and other controlling conditions, and finally subjected to crystallization and separation to obtain a fully water-soluble crystalline product. Another process is through by-production or specialized production of a fully water-soluble fertilizer using a device for producing potassium dihydrogen phosphate. The difficulty for the chemical synthesis of the water-soluble fertilizer is that during the synthesis reaction, while a solution of a single substance is easy to handle, when there is a circulating solution containing two phases, three phases or even more phases, co-crystallization phenomenon will occur during the crystallization by cooling at low temperature. That is to say, a complicated compounded salt is actually formed during the precipitation of the product, which directly causes the nutrient contents of nitrogen, phosphorus and potassium of the product to fluctuate, and will not cause the product to be precipitated based on the formulation ratio as expected.

### DISCLOSURE OF THE INVENTION

In view of the deficiencies of the prior art, the present invention provides a microgranular water-soluble fertilizer co-produced from potassium nitrate by tower melt and a method of preparing the same, so as to improve the appearance of the product, reduce the agglomeration, save energy, and facilitate production.

The technical solutions of the present invention are as follows:

The present invention provides a microgranular water-soluble fertilizer co-produced from potassium nitrate by tower melt, which comprises the following raw material components in parts by weight: 170 to 240 parts of potassium nitrate concentrate, 300 to 415 parts of urea, 60 to 125 parts of monoammonium phosphate, 70 to 140 parts of water-soluble ammonium polyphosphate, 260 to 340 parts of potassium sulfate, 1.0 to 3.0 parts of EDTA-Fe, 4.0 to 8.0 parts of EDTA-Zn, 4.0 to 6.0 parts of EDTA-Mn, 3.0 to 7.0 parts of boric acid, and 0 to 2.0 parts of ammonium heptamolybdate;

the potassium nitrate concentrate in the raw materials is obtained by quadruple-effect evaporation and centrifugation of potassium nitrate, with the potassium nitrate produced by ion exchange method, and the potassium nitrate concentrate contains 90 to 95% of potassium nitrate, 12.4% of nitrogen, and 42.3% of potassium oxide;

the rest of the raw materials are all commercially available, wherein:

the urea is in the form of small sized granules, with an N content of ≥46.2% and a grain size of 0.85 mm to 2.80 mm;

the monoammonium phosphate is industrially powdered monoammonium phosphate, with an N content of ≥12% and a P₂O₅ content of ≥61%;

the water-soluble ammonium polyphosphate is in the form of white powder, with an N content of ≥24% and a P₂O₅ content of ≥45%;

the potassium sulfate is in the form of white powder, with a K₂O content of ≥51%;

the boric acid is in the form of white powder, which is an industrially first grade product with a B content of ≥17%;

the EDTA chelated zinc is in the form of white powder, with a Zn content of ≥15%;

the EDTA chelated iron is in the form of yellow powder, with a Fe content of ≥13%;

the EDTA chelated manganese is in the form of light red powder, with a Mn content of ≥13%;

the ammonium heptamolybdate is in the form of white crystal, with a Mo content of ≥54%;

all the contents in the raw materials above are expressed in mass percentage.

Preferably, the microgranular water-soluble fertilizer co-produced from potassium nitrate by tower melt of the present invention comprises the following raw material components in parts by weight: 240 parts of potassium nitrate concentrate, 300 parts of urea, 105 parts of monoammonium phosphate, 90 parts of water-soluble ammonium polyphosphate, 310 parts of potassium sulfate, 3.0 parts of EDTA-Fe, 8.0 parts of EDTA-Zn, 6.0 parts of EDTA-Mn, 7.0 parts of boric acid, and 1.0 part of ammonium heptamolybdate.

The microgranular water-soluble fertilizer of the present invention is produced by using a production process employing fully automatic dispensing equipment, which mainly integrates “dispensing, mixing, and packaging”, each of which is fully automated.

A method of preparing a microgranular water-soluble fertilizer co-produced from potassium nitrate by tower melt comprises the following specific steps:

(1) the urea in the raw material is molten at a high temperature of 130° C. to 140° C., introduced into a buffer tank, pressurized by a delivery pump, weighted, and then conveyed into a mixing tank at tower top;

(2) the potassium nitrate concentrate which is generated by a method of ion exchange for producing potassium nitrate is centrifuged, separated, weighted, and then delivered through a duct into an agitator by air;

(3) the EDTA-Fe, EDTA-Zn, EDTA-Mn, boric acid, and ammonium heptamolybdate are pre-mixed in a specified ratio first, then the pre-mixed materials, monoammonium phosphate, water-soluble ammonium polyphosphate and potassium sulfate are each weighted, and conveyed into the agitator and mixed thoroughly; the mixed materials, after being crushed and sieved, are conveyed into a mixture heater and heated to 70° C. to 90° C., and then elevated to a silo at the tower top by a bucket elevator;

(4) the heated mixture in the silo at the tower top in step (3) is evenly weighted by a screw weighting device, conveyed into the mixing tank in step (1), and mixed by a high-speed shear mixer to prepare a dilute paste-like material at a temperature controlled at 100° C. to 120° C. The mixture is spilled (overflown) to a granulation nozzle after particulate impurities are filtered therefrom by a vibrating filter, and the mixture is evenly sprayed into small spherical droplets under the action of rotational shear centrifugal force of the nozzle; the small droplets sprayed by the nozzle is dropped slowly in a tower having a diameter of 5-6 meters and a height of 50-60 meters, and is cooled to 45° C. to 65° C. by heat exchange with a rising air flow in the tower to produce a microgranular water-soluble fertilizer. The microgranular water-soluble fertilizer is weighted and packaged after being subjected to cooling, sieving and anti-caking.

The microgranular water-soluble fertilizer of the present invention and its production process have the following advantages:

1. The Product has Balanced and Stable Nutrients

This process integrates, at the micro-molecular level, raw materials such as urea, potassium nitrate, industrial ammonium phosphate, water-soluble ammonium polyphosphate, potassium sulfate and the like into an entirety of organic nutrients, which form a balanced stable nutrient unit through synergistic effects among various nutrients, and ensures the balance and stability of nutrient ingredients of the fertilizer.

2. The Product is Microgranular, has a Round and Smooth Appearance, and is Less Susceptible to Agglomeration

This process employs tower melt granulation and effectively reduces the moisture of the product through heating and melting, as well as preheating of powdery materials. As a result, the product is microgranular, has a uniform appearance and large compressive strength, and is less susceptible to agglomeration.

3. Long-Acting Nitrogen and Fast-Acting Nitrogen are Combined in the Product to Facilitate Absorption and Utilization of the Product by Crops

The present product contains nitrate nitrogen that exerts a fast manurial effect; and the water-soluble ammonium polyphosphate contains slow-release nitrogen. Long-acting nitrogen and fast-acting nitrogen are combined with each other so as to meet the needs of crops in various time periods and thus improve the efficiency of utilization of the fertilizer.

4. The Product has a Full Range of Nutrients

The product contains medium- and micro-elements such as sulfur, iron, zinc, manganese, boron, and molybdenum that are easily absorbed by crops in addition to macro-elements such as nitrogen, phosphorus and potassium that are essential to the crop growth, and thus has a full range of nutrients.

5. Energy Saving

The present process employs an ion exchange method to produce potassium nitrate, which undergoes quadruple-effect evaporation to produce a concentrate. The concentrate is brought into production directly after being centrifuged and separated, thereby reducing the process of producing a powdered material from potassium nitrate. Further, the potassium nitrate concentrate is at a temperature of 90° C., which saves energy for preheating the raw material, and thus greatly saves the energy.

### DETAILED DESCRIPTION OF EMBODIMENTS

### EXAMPLE 1

The microgranular water-soluble fertilizer produced by the present invention includes the following raw material components, each expressed in parts by weight: 200 parts of potassium nitrate concentrate, 350 parts of urea, 125 parts of industrial monoammonium phosphate, 100 parts of water-soluble ammonium polyphosphate, 270 parts of potassium sulfate, 1.0 part of EDTA-Fe, 7.0 parts of EDTA-Zn, 4.0 parts of EDTA-Mn, 3.0 parts of boric acid and 0.2 part of ammonium heptamolybdate.

The detailed production process is as follows:

(1) The urea was molten at a high temperature of 130° C. and introduced into a buffer tank. It is then pressurized by a delivery pump, weighted and then conveyed into a mixing tank at tower top.

(2) The potassium nitrate concentrate which is generated by a method of ion exchange for production of potassium nitrate was centrifuged and separated, weighted, and then delivered into an agitator through a duct by air.

(3) The EDTA-Fe, EDTA-Zn, EDTA-Mn, boric acid, and ammonium heptamolybdate were pre-mixed first, and then the pre-mixed materials, industrial monoammonium phosphate, water-soluble ammonium polyphosphate and potassium sulfate were each weighted. The weighted materials were then conveyed into the agitator and mixed thoroughly. The mixed materials, after being crushed and sieved, were conveyed into a mixture heater and heated to 70° C. The heated mixtures were then elevated to a silo at the tower top by a bucket elevator.

(4) The heated mixtures in the silo at the tower top were evenly weighted by a screw weighting device, conveyed into the mixing tank, and mixed by a high-speed shear mixer to prepare a dilute paste-like material, and the dilute paste-like material is controlled at a temperature of 100° C. After particulate impurities were filtered out by a vibrating filter, the mixtures were spilled to a granulation nozzle and evenly sprayed into small spherical droplets under the action of rotational shear centrifugal force of the nozzle. The small droplets sprayed by the nozzle were dropped slowly in a tower having a diameter of 5 meters and a height of 50 meters, and were cooled to 45° C. by heat exchange with a rising air flow in the tower to became a microgranular water-soluble fertilizer. The water-soluble fertilizer was weighted and packaged after being subjected to cooling, sieving and anti-caking.

The obtained product has a specification of 22-12-22. The product includes micro-elements and water-soluble ammonium polyphosphate.

### EXAMPLE 2

300 parts of urea, 180 parts of potassium nitrate concentrate, 2.0 parts of EDTA-Fe, 4.0 parts of EDTA-Zn, 4.0 parts of EDTA-Mn, 5.0 parts of boric acid, 0 part of ammonium heptamolybdate, 125 parts of industrial monoammonium phosphate, 105 parts of water-soluble ammonium polyphosphate and 325 parts of potassium sulfate were provided.

The detailed production process was the same as Example 1:

(1) The urea was molten at a high temperature of 140° C. and introduced into a buffer tank. It is then pressurized by a delivery pump, weighted and then conveyed into a mixing tank at tower top.

(2) The potassium nitrate concentrate which is generated by a method of ion exchange for production of potassium nitrate was centrifuged and separated, weighted, and then delivered into an agitator via a duct by air.

(3) The EDTA-Fe, EDTA-Zn, EDTA-Mn, boric acid, and ammonium heptamolybdate were pre-mixed first, and then the pre-mixed materials, industrial monoammonium phosphate, water-soluble ammonium polyphosphate and potassium sulfate were each weighted. The weighted materials were then conveyed into the agitator and mixed thoroughly. The mixed materials, after being crushed and sieved, were conveyed into a mixture heater and heated to 90° C. The heated mixtures were then elevated to a silo at the tower top by a bucket elevator.

(4) The heated mixtures in the silo at the tower top were evenly weighted by a screw weighting device, conveyed into the mixing tank, and mixed by a high-speed shear mixer to prepare a dilute paste-like material at a temperature controlled at 120° C. After particulate impurities were filtered out by a vibrating filter, the mixtures were spilled to a granulation nozzle and the mixtures were evenly sprayed into small spherical droplets under the action of rotational shear centrifugal force of the nozzle. The small droplets sprayed by the nozzle were dropped slowly in a tower having a diameter of 6 meters and a height of 60 meters, and were cooled to 65° C. by heat exchange with a rising air flow in the tower, to produce a microgranular water-soluble fertilizer. The water-soluble fertilizer was weighted and packaged after being subjected to cooling, sieving and anti-caking.

The obtained product has a specification of 20-12-24. The product does not include molybdenum, but includes micro-elements and water-soluble ammonium polyphosphate.

### EXAMPLE 3

300 parts of urea, 240 parts of potassium nitrate concentrate, 3.0 parts of EDTA-Fe, 8.0 parts of EDTA-Zn, 6.0 parts of EDTA-Mn, 7.0 parts of boric acid, 1.0 part of ammonium heptamolybdate, 105 parts of industrial monoammonium phosphate, 90 parts of water-soluble ammonium polyphosphate and 310 parts of potassium sulfate were provided.

The detailed production process was the same as Example 1.

The obtained product has a specification of 20-10-26. The product includes micro-elements and water-soluble ammonium polyphosphate.

### EXAMPLE 4

415 parts of urea, 170 parts of potassium nitrate concentrate, 1.0 part of EDTA-Fe, 4.0 parts of EDTA-Zn, 6.0 parts of EDTA-Mn, 3.0 parts of boric acid, 1.0 part of ammonium heptamolybdate, 120 parts of industrial monoammonium phosphate, 70 parts of water-soluble ammonium polyphosphate and 260 parts of potassium sulfate were taken.

The detailed production process was the same as Example 1.

The obtained product has a specification of 24-10-20. The product includes micro-elements and water-soluble ammonium polyphosphate.

### EXAMPLE 5

300 parts of urea, 200 parts of potassium nitrate concentrate, 2.0 parts of EDTA-Fe, 7.0 parts of EDTA-Zn, 5.0 parts of EDTA-Mn, 4.0 parts of boric acid, 2.0 parts of ammonium heptamolybdate, 60 parts of industrial monoammonium phosphate, 140 parts of water-soluble ammonium polyphosphate and 340 parts of potassium sulfate were provided.

The detailed production process was the same as Example 1.

The obtained product has a specification of 20-10-25. The product includes micro-elements and water-soluble ammonium polyphosphate.

Manurial Effect Test

1. Overview of the Test

As a fully water-soluble and fast-acting fertilizer, the microgranular water-soluble fertilizer co-produced from potassium nitrate by tower melt of the present invention is suitable for a majority of crops, and particularly suitable for use as top dressing (follow-up fertilizer) for economic crops like fruits and vegetables. Eggplants were selected as test crop in the field test.

The test site was located at Stanley's Modern Agricultural Ecological Demonstration Garden, Zhouzhuang Town, Linshu County, Linyi City, Shandong Province of China.

2. Test Materials and Design

The test soil was cinnamon soil having the following nutrient contents:

1.21% of organic matter, 121 mg/kg of alkali-hydrolyzable nitrogen, 17 mg/kg of fast-acting phosphorus (P₂O₅), and 134 mg/kg of fast-acting potassium (K₂O).

The test crop was eggplant, the species of which was long eggplant No. 2.

A total of six treatments were provided (see Table 1 for the specific treatments), and each treatment was repeated 3 times and arranged in a randomized block. The test plot had an area of 66.7 m², a rectangular shape of 10 m×6.7 m, and was surrounded by protection rows. The eggplants were planted at a density of 2500 plants/mu with a row spacing of 70 cm×50 cm.

For all the treatments, 15-15-15 sulfur-based fertilizer was applied at 30 kg/mu as a base fertilizer, and top dressing was applied 25 days after planting. A treatment fertilizer was applied at 10 kg/mu together with watering every 15 days. The eggplants were transplanted on Jan. 10, 2014, harvested from March 31 and completed on June 10. The growth period was 151 days in total.

TABLE 1
Fertilization of Eggplants

| | | Fertilizer Application Amount (kg/plot) | | | | | | | |
|---|---|---|---|---|---|---|---|---|---|
| | | Fertilizer Application Mode | | | | | | | |
| | | | | | | | | top | top |
| | | | top | top | top | top | top | dressing | dressing |
| | | | dressing | dressing | dressing | dressing | dressing | 100 | 115 |
| | | | 25 days | 40 days | 55 days | 70 days | 85 days | days | days |
| Treatment | Fertilizer | base | after | after | after | after | after | after | after |
| Number | Formulation | fertilizer | planting | planting | planting | planting | planting | planting | planting |
| CK | 14-14-28 | 3.0 | 1.0 | 1.0 | 1.0 | 1.0 | 1.0 | 1.0 | 1.0 |
| | conventional | spreading | drip | drip | drip | drip | drip | drip | drip |
| | water-soluble | | irrigation | irrigation | irrigation | irrigation | irrigation | irrigation | irrigation |
| | fertilizer | | | | | | | | |
| A | Example 1 | 3.0 | 1.0 | 1.0 | 1.0 | 1.0 | 1.0 | 1.0 | 1.0 |
| | (22-12-22) | spreading | drip | drip | drip | drip | drip | drip | drip |
| | | | irrigation | irrigation | irrigation | irrigation | irrigation | irrigation | irrigation |
| B | Example 2 | 3.0 | 1.0 | 1.0 | 1.0 | 1.0 | 1.0 | 1.0 | 1.0 |
| | (20-12-24) | spreading | drip | drip | drip | drip | drip | drip | drip |
| | | | irrigation | irrigation | irrigation | irrigation | irrigation | irrigation | irrigation |
| C | Example 3 | 3.0 | 1.0 | 1.0 | 1.0 | 1.0 | 1.0 | 1.0 | 1.0 |
| | (20-10-26) | spreading | drip | drip | drip | drip | drip | drip | drip |
| | | | irrigation | irrigation | irrigation | irrigation | irrigation | irrigation | irrigation |
| D | Example 4 | 3.0 | 1.0 | 1.0 | 1.0 | 1.0 | 1.0 | 1.0 | 1.0 |
| | (24-10-20) | spreading | drip | drip | drip | drip | drip | drip | drip |
| | | | irrigation | irrigation | irrigation | irrigation | irrigation | irrigation | irrigation |
| E | Example 5 | 3.0 | 1.0 | 1.0 | 1.0 | 1.0 | 1.0 | 1.0 | 1.0 |
| | (20-10-25) | spreading | drip | drip | drip | drip | drip | drip | drip |
| | | | irrigation | irrigation | irrigation | irrigation | irrigation | irrigation | irrigation |

3. Measurement Indexes and Method

Eggplant yield measurement: the total yield from each treatment was measured in unit of kg.

Number of eggplant fruits: the number of eggplant fruits was counted.

Measurement of the weight of a single fruit of eggplant: the weight of an eggplant fruit was measured in unit of kg.

Test Results and Analysis

TABLE 2
Influence of Different Fertilization Treatments on Indexes of
Eggplant Yield

| | | | | | | Weight | | | |
|---|---|---|---|---|---|---|---|---|---|
| | | | | | | of | | | |
| | | | | Number of | | Single | | | |
| | | Plant | Number of | Fruits Per | | Fruit | | Number of Fruit | Theoretical |
| Treatment | Fertilizer | Height | Plants | Plant | | Weight | | Branches | Yield |
| Number | Formulation | (cm) | (plants/mu) | (fruits/plant) | | (g/fruit) | | (branches/plant) | (kg/mu) |
| Control | 14-14-28 | 97 b | 2511 | 12.3 | c | 100 | b | 7 a | 3088.53 d |
| | conventional | | | | | | | | |
| | water-soluble | | | | | | | | |
| | fertilizer | | | | | | | | |
| A | Example 1 | 107 a | 2513 | 13.4 | b | 109 | b | 7 a | 3670.49 b |
| | (22-12-22) | | | | | | | | |
| B | Example 2 | 104 a | 2504 | 13.0 | ab | 106 | ab | 8 a | 3450.51 c |
| | (20-12-24) | | | | | | | | |
| C | Example 3 | 105 a | 2507 | 13.9 | a | 112 | a | 8 a | 3902.90 a |
| | (20-10-26) | | | | | | | | |
| D | Example 4 | 108 a | 2506 | 13.5 | ab | 111 | a | 8 a | 3755.24 b |
| | (24-10-20) | | | | | | | | |
| E | Example 5 | 104 a | 2509 | 13.6 | a | 111 | a | 8 a | 3787.59 b |
| | (20-10-25) | | | | | | | | |

Note:
Different letters in the same column in the table indicate that a difference between different fertilizations reaches a significant level of 5% (the same below).

As can be seen from Table 2, different fertilizations have significant effects on the plant height, number of fruits per plant, weight of single fruit, and theoretical yield of the eggplant.

In the present invention, the microgranular water-soluble fertilizer co-produced from potassium nitrate by tower melt may include the following raw material components in parts by weight: 300 to 415 parts of urea, 170 to 240 parts of potassium nitrate concentrate, 1.0 to 3.0 of EDTA-Fe, 4.0 to 8.0 parts of EDTA-Zn, 4.0 to 6.0 parts of EDTA-Mn, 3.0 to 7.0 parts of boric acid, 0 to 2.0 parts of ammonium heptamolybdate, 60 to 125 parts of monoammonium phosphate, 70 to 140 parts of water-soluble ammonium polyphosphate and 260 to 340 parts of potassium sulfate. The microgranular water-soluble fertilizer achieved good effects in terms of plant height, number of fruits per plant, weight of single fruit, and theoretical yield of the eggplant, etc.

In the present invention, the microgranular water-soluble fertilizer co-produced from potassium nitrate by tower melt may comprise the following raw material components in parts by weight: 300 to 415 parts of urea, 170 to 240 parts of potassium nitrate concentrate, 1.0 to 3.0 of EDTA-Fe, 4.0 to 8.0 parts of EDTA-Zn, 5.0 to 6.0 parts of EDTA-Mn, 3.0 to 7.0 parts of boric acid, 1.0 to 2.0 parts of ammonium heptamolybdate, 60 to 105 parts of monoammonium phosphate, 70 to 140 parts of water-soluble ammonium polyphosphate and 260 to 340 parts of potassium sulfate. The microgranular water-soluble fertilizer achieved good effects in terms of plant height, number of fruits per plant, weight of single fruit, and theoretical yield of the eggplant, etc.

For example, the plant height was significantly higher in each of the five examples than in the control. In terms of the number of fruits per plant, the largest was in Treatment C, i.e., Example 3 (20-10-26, containing micro-elements and water-soluble ammonium polyphosphate), which was significantly higher (13.0% higher) than that of the control (treatment with 14-14-28 conventional water-soluble fertilizer). Treatment C had the largest weight of single fruit and was 12.0% higher than that of the control. There was no significant difference in the number of fruit branches among the various treatments. Treatment C had the largest theoretical yield and was significantly higher than the control and other examples. Treatment C showed an increase of 814.37 kg per mu and an increase rate of 26.4% as compared to the control, showed an increase of 232.41 kg per mu and an increase rate of 6.3% as compared to Treatment A (Example 1, 22-12-22, containing micro-elements and water-soluble ammonium polyphosphate), showed an increase of 452.39 kg per mu and an increase rate of 13.11% as compared to Treatment B (Example 2, 20-12-24, containing no molybdenum, and containing other micro-elements and water-soluble ammonium polyphosphate), showed an increase of 147.66 kg per mu and an increase rate of 3.9% as compared to Treatment D (Example 4, 24-10-20, containing micro-elements and water-soluble ammonium polyphosphate), and showed an increase of 115.31 kg per mu and an increase rate of 3.0% as compared to Treatment E (Example 5, 20-10-25, containing micro-elements and water-soluble ammonium polyphosphate).

In summary, the manurial effects of the above treatments on the eggplant yield are ranked as follows: Treatment C>Treatment D=Treatment E=Treatment A>Treatment B>Control. There is such a significant difference in effect between Example 3 and the control because, on the one hand, the formulation of Example 3 is more suitable as top dressing for solanaceous vegetables, and on the other hand, Example 3 contains micro-elements and water-soluble ammonium polyphosphate. Micro-elements are essential to the growth of eggplant, and can significantly promote vegetative growth and flowering of the eggplant after being supplemented. The water-soluble ammonium polyphosphate can effectively chelate the micro-elements to enhance the effects of these nutrient elements, and can also promote a sustained slow release function.

Therefore, Example 3 is the most appropriate nutrient formulation of the present invention, that is, 20-10-26 containing micro-elements and water-soluble ammonium polyphosphate.

1. A microgranular water-soluble fertilizer co-produced from potassium nitrate by tower melt, wherein the microgranular water-soluble fertilizer co-produced from potassium nitrate by tower melt comprises following components of raw materials in parts by weight: 170 to 240 parts of potassium nitrate concentrate, 300 to 415 parts of urea, 60 to 125 parts of monoammonium phosphate, 70 to 140 parts of water-soluble ammonium polyphosphate, 260 to 340 parts of potassium sulfate, 1.0 to 3.0 parts of EDTA-Fe, 4.0 to 8.0 parts of EDTA-Zn, 4.0 to 6.0 parts of EDTA-Mn, 3.0 to 7.0 parts of boric acid, and 0 to 2.0 parts of ammonium heptamolybdate;
the potassium nitrate concentrate in the raw materials is obtained by conducting quadruple-effect evaporation and centrifugation on potassium nitrate produced by an ion exchange method, and the potassium nitrate concentrate contains 90 to 95% of potassium nitrate, 12.4% of nitrogen, and 42.3% of potassium oxide;
rest of the raw materials are all commercially available, wherein:
the urea is urea in small sized granules, with an N content of ≥46.2% and a grain size of 0.85 mm to 2.80 mm;
the monoammonium phosphate is industrial powdered monoammonium phosphate, with an N content of ≥12% and a P₂O₅ content of ≥61%;
the water-soluble ammonium polyphosphate is in a form of white powder, with an N content of ≥24% and a P₂O₅ content of ≥45%;
the potassium sulfate is in a form of white powder, with a K₂O content of ≥51%;
the boric acid is in a form of white powder, which is an industrial first grade product with a B content of ≥17%;
the EDTA chelated zinc is in a form of white powder, with a Zn content of ≥15%;
the EDTA chelated iron is in a form of yellow powder, with a Fe content of ≥13%;
the EDTA chelated manganese is in a form of light red powder, with a Mn content of ≥13%;
the ammonium heptamolybdate is in a form of white crystal, with a Mo content of ≥54%;
all of the contents in the raw materials above are expressed in mass percentage.

2. The microgranular water-soluble fertilizer co-produced from potassium nitrate by tower melt according to claim 1, wherein the microgranular water-soluble fertilizer co-produced from potassium nitrate by tower melt comprises following components of raw materials in parts by weight: 300 to 415 parts of urea, 170 to 240 parts of potassium nitrate concentrate, 1.0 to 3.0 parts of EDTA-Fe, 4.0 to 8.0 parts of EDTA-Zn, 4.0 to 6.0 parts of EDTA-Mn, 3.0 to 7.0 parts of boric acid, 0 to 2.0 parts of ammonium heptamolybdate, 60 to 125 parts of monoammonium phosphate, 70 to 140 parts of water-soluble ammonium polyphosphate and 260 to 340 parts of potassium sulfate.

3. The microgranular water-soluble fertilizer co-produced from potassium nitrate by tower melt according to claim 1, wherein the microgranular water-soluble fertilizer co-produced from potassium nitrate by tower melt comprises following components of raw materials in parts by weight: 300 to 415 parts of urea, 170 to 240 parts of potassium nitrate concentrate, 1.0 to 3.0 parts of EDTA-Fe, 4.0 to 8.0 parts of EDTA-Zn, 5.0 to 6.0 parts of EDTA-Mn, 3.0 to 7.0 parts of boric acid, 1.0 to 2.0 parts of ammonium heptamolybdate, 60 to 105 parts of monoammonium phosphate, 70 to 140 parts of water-soluble ammonium polyphosphate and 260 to 340 parts of potassium sulfate.

4. The microgranular water-soluble fertilizer co-produced from potassium nitrate by tower melt according to claim 1, wherein the microgranular water-soluble fertilizer co-produced from potassium nitrate by tower melt comprises following components of raw materials in parts by weight: 240 parts of potassium nitrate concentrate, 300 parts of urea, 105 parts of monoammonium phosphate, 90 parts of water-soluble ammonium polyphosphate, 310 parts of potassium sulfate, 3.0 parts of EDTA-Fe, 8.0 parts of EDTA-Zn, 6.0 parts of EDTA-Mn, 7.0 parts of boric acid and 1.0 part of ammonium heptamolybdate.

5. A method of preparing the microgranular water-soluble fertilizer co-produced from potassium nitrate by tower melt according to claim 1, wherein the method comprises following steps:
(1) melting the urea, as one of the raw materials, at a high temperature of 130° C. to 140° C., introducing the molten urea into a buffer tank so as to be pressurized by a delivery pump, metering the pressurized urea, and conveying the metered urea into a mixing tank at top of a tower;
(2) conducting centrifugalization on the potassium nitrate concentrate generated by an ion exchange method used for producing potassium nitrate, metering the centrifugalized potassium nitrate concentrate and delivering by air the metered potassium nitrate concentrate into an agitator through a duct;
(3) premixing EDTA-Fe, EDTA-Zn, EDTA-Mn, boric acid and ammonium heptamolybdate in a specified ratio, metering each of the pre-mixed material, monoammonium phosphate, water-soluble ammonium polyphosphate and potassium sulfate, and conveying the metered materials into the agitator to be mixed thoroughly; crushing and sieving the obtained mixture, and then conveying the same into a mixture heater so as to be heated to 70° C. to 90° C., and using a bucket elevator to elevate the heated mixture to a silo at the top of the tower;
(4) using a screw weighting device to uniformly meter the heated mixture in the silo at the top of the tower top obtained in step (3), conveying the metered mixture into the mixing tank in step (1), and using a high-speed shear mixer to perform mixing to obtain a dilute paste-like material, and controlling the dilute paste-like material to be at a temperature of 100° C. to 120° C.; using a vibrating filter to filter out particulate impurities from the dilute paste-like material, and spilling the filtered dilute paste-like material to a granulation nozzle, and evenly spraying the mixture into small spherical droplets under an action of a rotational shear centrifugal force of the nozzle, wherein the small droplets sprayed out from the nozzle drop slowly in the tower with a diameter of 5-6 meters and a height of 50-60 meters, and are cooled to 45° C. to 65° C. through heat exchange with a rising air flow in the tower, to produce a microgranular water-soluble fertilizer; and conducting cooling, sieving and anti-caking processes on the microgranular water-soluble fertilizer, and then metering and packaging the microgranular water-soluble fertilizer.

6. The method according to claim 5, wherein the microgranular water-soluble fertilizer co-produced from potassium nitrate by tower melt comprises following components of raw materials in parts by weight: 300 to 415 parts of urea, 170 to 240 parts of potassium nitrate concentrate, 1.0 to 3.0 parts of EDTA-Fe, 4.0 to 8.0 parts of EDTA-Zn, 4.0 to 6.0 parts of EDTA-Mn, 3.0 to 7.0 parts of boric acid, 0 to 2.0 parts of ammonium heptamolybdate, 60 to 125 parts of monoammonium phosphate, 70 to 140 parts of water-soluble ammonium polyphosphate and 260 to 340 parts of potassium sulfate.

7. The method according to claim 5, wherein the microgranular water-soluble fertilizer co-produced from potassium nitrate by tower melt comprises following components of raw materials in parts by weight: 300 to 415 parts of urea, 170 to 240 parts of potassium nitrate concentrate, 1.0 to 3.0 parts of EDTA-Fe, 4.0 to 8.0 parts of EDTA-Zn, 5.0 to 6.0 parts of EDTA-Mn, 3.0 to 7.0 parts of boric acid, 1.0 to 2.0 parts of ammonium heptamolybdate, 60 to 105 parts of monoammonium phosphate, 70 to 140 parts of water-soluble ammonium polyphosphate and 260 to 340 parts of potassium sulfate.

8. The method according to claim 5, wherein the microgranular water-soluble fertilizer co-produced from potassium nitrate by tower melt comprises following components of raw materials in parts by weight: 240 parts of potassium nitrate concentrate, 300 parts of urea, 105 parts of monoammonium phosphate, 90 parts of water-soluble ammonium polyphosphate, 310 parts of potassium sulfate, 3.0 parts of EDTA-Fe, 8.0 parts of EDTA-Zn, 6.0 parts of EDTA-Mn, 7.0 parts of boric acid and 1.0 part of ammonium heptamolybdate.
